(19) United States
(12) Patent Application Publication
(10) Pub. No.: US 2014/0182456 A1
(43) Pub. Date: Jul. 3, 2014

(54) Debinder Trap

(71) Applicant: CHENG UEI PRECISION INDUSTRY CO., LTD., New Taipei City (TW)

(72) Inventors: Cheng Yu Chou, New Taipei City (TW); Che Wei Hsu, New Taipei City (TW); Chih Wei Cheng, New Taipei City (TW)

(73) Assignee: CHENG UEI PRECISION INDUSTRY CO., LTD., New Taipei City (TW)

(21) Appl. No.: 13/729,020

(22) Filed: Dec. 27, 2012

(51) Int. Cl. B01D 45/10

(52) U.S. Cl. CPC B01D 45/10
USPC 96/239

(57) ABSTRACT

A debinder trap for treating binder gas thermal-cracked in sintering process of metal injection molding includes a hollow barrel body having a barrel cover, a barrel wall and a barrel bottom, and a plurality of baffles disposed in the barrel body to define a guide channel. An inlet and an outlet are apart opened in the barrel cover. The entrance of the guide channel is communicated with the inlet of the barrel body and the exit of the guide channel is communicated with the outlet of the barrel body. The barrel body contains oil material therein. In use, the binder gas enters the barrel body through the inlet and flows along the guide channel for being adsorbed by the oil material and rapidly condensed into solid binder, and the solid binder is dissolved and precipitated in the oil material to make the oil material continue to adsorb the binder gas.

### BACKGROUND OF THE INVENTION

1. Field of the Invention

The present invention generally relates to a debinder trap used in the process of metal injection molding, and more particularly to a debinder trap capable of effectively treating binder gas thermal-cracked in sintering process of the metal injection molding.

2. The Related Art

Metal injection molding is a metalworking process where finely-powdered metal is mixed with a measured amount of binder material to comprise a feedstock capable of being handled by plastic processing equipment through a process known as injection mold forming. Subsequent conditioning operations are performed on the molded shape, where the binder material is removed and metal particles are coalesced into the desired state for the metal alloy. In detail, the binder material is thermal-cracked into binder gas in sintering process of the metal injection molding. When the binder gas is directly pumped by a vacuum pump, it will severely impair the vacuum pump on account of the binder gas being condensed to accumulate in the vacuum pump and deteriorate lubrication oil, etc. Therefore, in order to protect the vacuum pump, a debinder trap is used to treat the binder gas.

At present, the conventional debinder trap generally utilizes air condensation effect to condense the binder gas—passing through the debinder trap—into solid so as to be adhered on inner walls thereof for being treated some time later. However, with the difference of the binder material, sintering temperature and so on, they are very different in quantity, velocity and characteristic of the binder gas being thermal-cracked in the sintering process. If a large amount of binder gas is released in short time, most of the binder gas will fail to be effectively condensed by the conventional debinder trap only utilizing the air condensation effect, and further pass through the debinder trap into the vacuum pump. It will impair the vacuum pump over again. So, a debinder trap capable of effectively treating the binder gas thermal-cracked in the sintering process of the metal injection molding is required.

### SUMMARY OF THE INVENTION

An object of the present invention is to provide a debinder trap for treating binder gas thermal-cracked in sintering process of metal injection molding. The debinder trap includes a hollow barrel body having a barrel cover, a barrel wall and a barrel bottom, and a plurality of baffles disposed in the barrel body to define a guide channel. An inlet and an outlet are apart opened in the barrel cover. The entrance of the guide channel is communicated with the inlet of the barrel body and the exit of the guide channel is communicated with the outlet of the barrel body. The barrel body contains oil material therein. In use, the binder gas enters the barrel body through the inlet and flows along the guide channel for being adsorbed by the oil material and rapidly condensed into solid binder, and the solid binder is dissolved and precipitated in the oil material to make the oil material continue to adsorb the binder gas.

As described above, the debinder trap of the present invention defines the guide channel to guide the binder gas to flow therethrough, in the process of the binder gas flowing along the guide channel, the debinder trap utilizes the characteristics of the oil material to act the oil material as absorption media so as to effectively treat the binder gas.

### BRIEF DESCRIPTION OF THE DRAWINGS

The present invention will be apparent to those skilled in the art by reading the following description, with reference to the attached drawings, in which:

FIG. 1 is a partially perspective sectional view of a debinder trap according to an embodiment of the present invention;

FIG. 2 is a cross-sectional view of the debinder trap of FIG. 1 where oil material is contained; and

FIG. 3 is another partially perspective sectional view of the debinder trap of FIG. 1.

### DETAILED DESCRIPTION OF THE PREFERRED EMBODIMENT

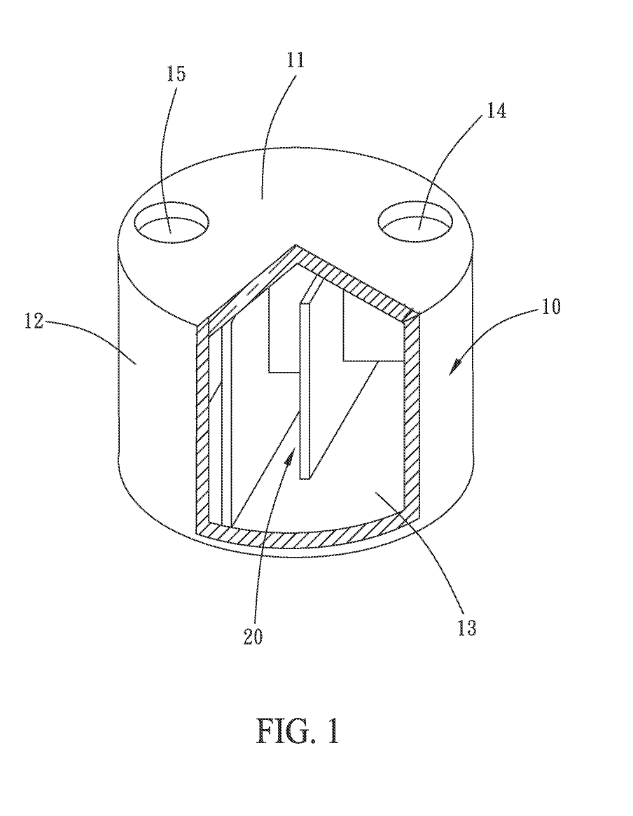

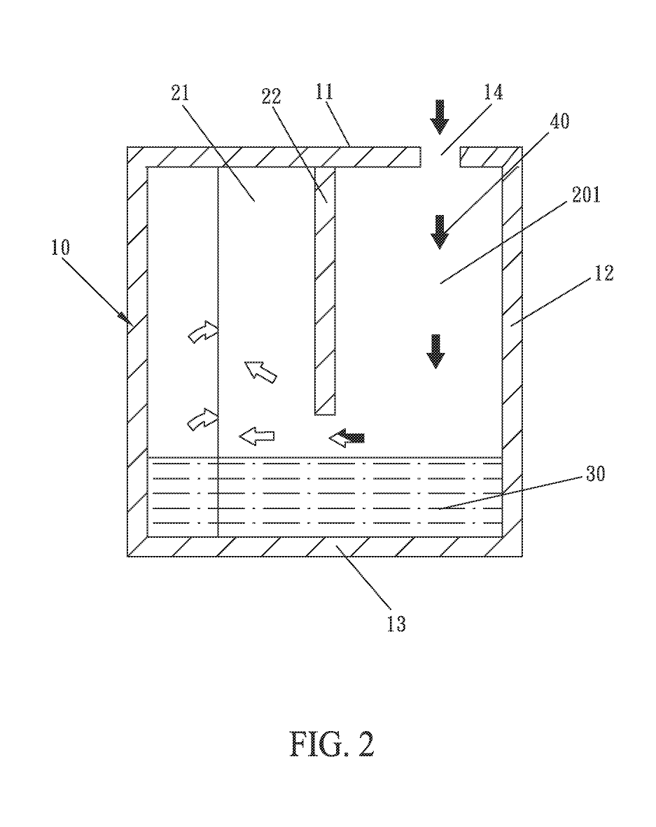

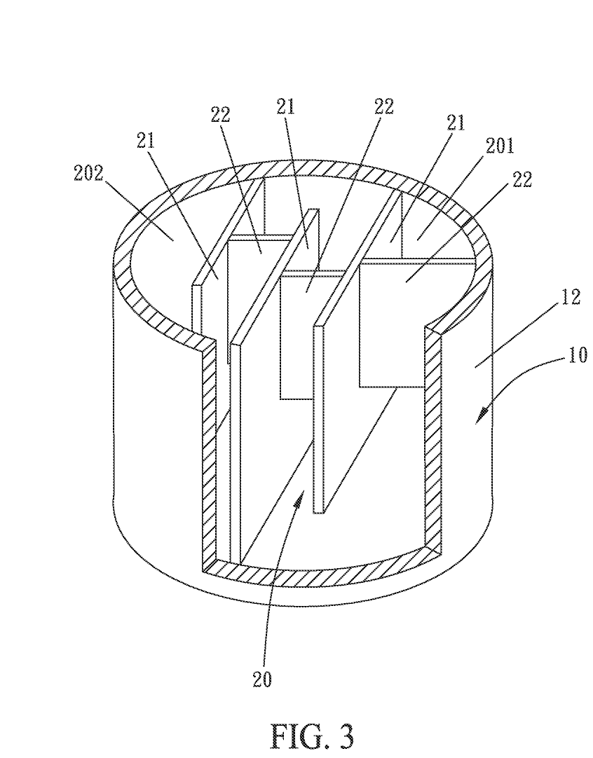

With reference to FIG. 1, FIG. 2 and FIG. 3, a debinder trap in accordance with an embodiment of the present invention is used for treating binder gas 40 thermal-cracked in sintering process of metal injection molding. The debinder trap includes a hollow barrel body 10 having a barrel cover 11, a barrel wall 12 and a barrel bottom 13, and a plurality of baffles disposed in the barrel body 10 to define a guide channel 20. An inlet 14 and an outlet 15 are apart opened in the barrel cover 11. The entrance 201 of the guide channel 20 is communicated with the inlet 14 of the barrel body 10 and the exit 202 of the guide channel 20 is communicated with the outlet 15 of the barrel body 10. The barrel body 10 contains oil material 30 therein.

In use, the binder gas 40 enters the barrel body 10 through the inlet 14 and flows along the guide channel 20 for being adsorbed by the oil material 30 and rapidly condensed into solid binder, and the solid binder is dissolved and precipitated in the oil material 30 to make the oil material 30 continue to adsorb the binder gas 40.

Referring to FIG. 2 and FIG. 3 again, the baffles include a plurality of longitudinal baffles 21 and a plurality of transverse baffles 22. The longitudinal baffles 21 apart parallel to one another and vertically connect the barrel cover 11 and the barrel bottom 13. Each of the longitudinal baffles 21 has one side edge connected with the barrel wall 12 and the other side edge spaced from the barrel wall 12. The longitudinal baffles 21 are alternately arranged to make the guide channel 20 show continuous S-shape. Each of the transverse baffles 22 is vertically and perpendicularly connected between two adjacent longitudinal baffles 21. The transverse baffles 22 have top edges connected with the barrel cover 11 and bottom edges away from the barrel bottom 13. The level of the oil material 30 is below the bottom edges of the transverse baffles 22 for guiding the binder gas 40 to pass therebetween so as to effectively treat the binder gas 40 with the oil material 30.

In this embodiment, one transverse baffle 22 is further perpendicularly connected between one outmost longitudinal baffle 21 and the barrel wall 12. The entrance 201 of the guide channel 20 is surrounded by the transverse baffle 22, the inner wall 12, a part of the outmost longitudinal baffle 21 connected with the inner wall 12, and a part of the barrel cover 11 opened with the inlet 14.

After the binder gas 40 enters the debinder trap from the inlet 14, the binder gas 40 is obstructed by the transverse baffles 22 in succession to flow towards the oil face of the oil material 30 and contact react with the oil material 30 into the solid binder. The solid binder is rapidly dissolved and precipitated in the oil material 30 to keep the oil surface of the oil material 30 clean so as to continue to treat the binder gas 40. So the debinder trap of the present invention can continuously and effectively treat the binder gas 40.

As described above, the debinder trap of the present invention defines the guide channel 20 to guide the binder gas 40 to flow therethrough. In the process of the binder gas 40 flowing along the guide channel 20, the debinder trap utilizes the characteristics of the oil material 30 to act the oil material 30 as absorption media so as to effectively treat the binder gas 40.

What is claimed is:

1. A debinder trap for treating binder gas thermal-cracked in sintering process of metal injection molding, comprising:
a hollow barrel body having a barrel cover, a barrel wall and a barrel bottom, an inlet and an outlet being apart opened in the barrel cover; and
a plurality of baffles disposed in the barrel body to define a guide channel of which the entrance is communicated with the inlet of the barrel body and the exit is communicated with the outlet of the barrel body;
wherein the barrel body contains oil material therein, in use, the binder gas enters the barrel body through the inlet and flows along the guide channel for being adsorbed by the oil material and rapidly condensed into solid binder, the solid binder is dissolved and precipitated in the oil material to make the oil material continue to adsorb the binder gas.

2. The debinder trap as claimed in claim 1, wherein the baffles include a plurality of longitudinal baffles and a plurality of transverse baffles, the longitudinal baffles apart parallel to one another and vertically connect the barrel cover and the barrel bottom, each of the longitudinal baffles has one side edge connected with the barrel wall and the other side edge spaced from the barrel wall, the longitudinal baffles are alternately arranged to make the guide channel show continuous S-shape, each of the transverse baffles is vertically and perpendicularly connected between two adjacent longitudinal baffles, the transverse baffles have top edges connected with the barrel cover and bottom edges away from the barrel bottom, the level of the oil material is below the bottom edges of the transverse baffles for guiding the binder gas to pass therebetween so as to effectively treat the binder gas with the oil material.

3. The debinder trap as claimed in claim 1, wherein one transverse baffle is further perpendicularly connected between one outmost longitudinal baffle and the barrel wall, the entrance of the guide channel is surrounded by the transverse baffle, the inner wall, a part of the outmost longitudinal baffle connected with the inner wall, and a part of the barrel cover opened with the inlet.
